(19) United States
(12) Patent Application Publication
(10) Pub. No.: US 2008/0227020 A1
(43) Pub. Date: Sep. 18, 2008

(54) Preparation of Toner from Latex Wax Composites

(76) Inventors: Rick Owen Jones, Berthoud, CO (US); Lale Gokbudak Lovell, Longmont, CO (US); Walter Mychajlowskij, Superior, CO (US); John Melvin Olson, Boulder, CO (US); Kasturi Rangan Srinivasan, Longmont, CO (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/685,803

(22) Filed: Mar. 14, 2007

(51) Int. Cl. G03G 5/10

(52) U.S. Cl. 430/137.14

(57) ABSTRACT

The present disclosure relates to chemically processed toner, wherein fuser release agent (wax) may be dispersed in a fluid containing a dispersant. Introduced to the wax dispersion are one or more polymerizable monomers which may be polymerized to form a latex of polymer particles. The polymer particles may then serve as a binder for the formation of toner for use in an electrophotographic printer. The polymerizable monomers may utilize acrylic esters that include relatively long chain hydrocarbon type substitution.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Invention

The present invention relates to methods of preparing toner and more specifically, the preparation of chemical toner from a latex containing a wax composition.

2. Description of the Related Art

Toner particles may be formed by the process of compounding a polymeric resin, with colorants and optionally other additives. These ingredients may be blended through, for example, melt mixing. The resultant materials may then be ground and classified by size to form a powder. Toner particulate compositions may also be formed by chemical methods in which the toner particles are prepared by chemical processes such as suspension polymerization or emulsion aggregation rather than being abraded from larger sized materials by physical processes. Toner compositions so formed may be used in electrophotographic printers and copiers, such as laser printers wherein an image may be formed via use of a latent electrostatic image which is then developed to form a visible image on a drum which may then be transferred onto a suitable substrate.

### SUMMARY OF THE INVENTION

The present disclosure relates to a method of forming a chemically processed toner. A wax dispersion may initially be formed comprising wax particles dispersed in a fluid containing a dispersant. Introduced to the wax dispersion are one or more polymerizable monomers which may be polymerized to form a latex of polymer particles in the wax dispersion. One may then introduce a dispersion containing pigment particles. This may be followed by forming clusters by inducing the wax, polymer and pigment particles to associate including growth of the clusters to form a plurality of loosely associated clusters. Heating then may be introduced at a temperature to fuse together the clustered particles to form coalesced particles of toner.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The present invention relates to toner and a method of providing toner including polymeric latex particles, wherein the latex particles may be prepared in the presence of a wax dispersion. The toner may also include a pigment and optionally additional waxes, as well as other additives to improve various toner characteristics. The toner may be a chemically processed toner wherein the toner may be formed via emulsion aggregation, or other processes, that may produce relatively small toner particle sizes.

In addition, the polymeric latex particles may be optionally sourced from acrylic esters that include a relatively long chain hydrocarbon. For example, acrylic esters of the following general formula:

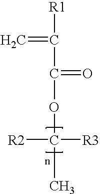

wherein R1, R2 and R3 may be a hydrogen, an alkyl group, a substituted alkyl group, an aryl group or a substituted aryl group, and wherein n is an integer have a value of greater than 5, including linear or branched side-chains. For example, the value of n may fall within the range of 5-25, including all values and increments therein. Such relatively long chain acrylic ester may be present at a level of equal to or greater than about 5.0% by weight (wt.) in a given polymer latex. For example, it may be present at a level of about 5.0% (wt.) to about 20.0% (wt.). One suitable acrylic ester is therefore lauryl methacrylate:

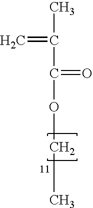

In an exemplary toner forming process, the toner may be prepared by mixing the polymer latex formed in the presence of a wax dispersion with a dispersion comprised of a pigment and, optionally, a wax or charge control agent. A charge control agent may be understood as a compound that may then assist in the production and stability of a tribocharge in the toner.

For example, the pigment, wax or charge control agent may be added as individual dispersions or as a combined dispersion. The mixture is then capable of flocculation by pH control, e.g., the addition of an inorganic salt or an acid. The submicron particles of latex, pigment and/or wax may be converted into micron sized particles by heating the mixture to induce association and the formation of a plurality of clusters having diameters of about 1-25 μm. The pH of the mixture may then be adjusted to, for example, alkaline conditions. Heating may then take place at temperatures above the softening temperature of the constituent polymer (e.g., above Tg) to fuse and form either substantially spherical or non-spherical particles. The toner may then be mixed with extra particulate additives, such as silica, titania or other inorganic oxides. Exemplary methods for forming particulate composition of toner are disclosed in U.S. Pat. Nos. 6,531,254 and 6,531,256, whose teachings are incorporated herein by reference.

Exemplary wax dispersions suitable for providing an environment for polymer latex formation include an olefin wax, metal salts of fatty acids, fatty acid esters, partially saponified fatty acid esters, higher fatty acid esters, higher alcohols, paraffin waxes, amide waxes or polyhydric alcohol ester type wax. Exemplary polyolefin waxes may include polyethylene wax having a melting point in the range of about 25-100° C., including all values and increments therein such as 60-85° C., etc. Exemplary ester waxes may include pentaerythritol tetrastearate having a melting point in the range of about 70 to 80° C., including all values and increments therein, such as 76-78° C. The wax may be present in the dispersion at about 1-25% solids (by weight) including all values and increments therein. For example, the wax may be present in the dispersion at a level of about 5% to about 10% by weight.

The wax dispersant that may be employed herein include those dispersants disclosed in U.S. Pat. No. 6,991,884, whose teachings are incorporated by reference. For example, the dispersant for the wax may include a copolymer. The dispersant copolymer may include a graft co-polymer wherein the co-polymer may contain at least two components including a hydrophilic component and a protective colloid component. The copolymer may also include more than two components, such as a hydrophobic component. The copolymer may be produced via free-radical polymerization. The polymeric dispersant may have a weight average molecular weight (Mw) from about 5,000 to about 30,000 as determined by gel permeation chromatography (GPC).

The hydrophilic component of the dispersant may be understood as one which may associate with water, which may be due to polarity considerations. For example, the hydrophilic component may include an ionic monomer segment which may be selected from acrylic acid, methacrylic acid, crotonic acid or other carboxylic acid containing monomers.

The protective colloid component includes a moiety that enables it to attach to the backbone hydrophilic segment of the polymer. Among other things, the protective colloid component may be one that enhances stability in aqueous systems and which may reduce the amount of ionic monomer component. The protective colloid may also stabilize the dispersion in lower acidic and in aqueous/alcoholic media, where a carboxylic acid group may be relatively ineffective for inducing dispersion stability. The protective colloid may also itself provide a hydrophobic functional group that may have relatively strong interaction for pigment or fuser release agent (wax).

The protective colloid may include materials such as hydroxylethylcellulose acrylate, hydroxyethylcellulose methacrylate, methoxypoly(ethyleneoxy) acrylate (containing from about 0 to about 40 moles of ethylene oxide), methoxypoly(ethyleneoxy) methacrylate (containing from about 0 to about 40 moles of ethylene oxide), methylcellulose acrylate, methylcellulose methacrylate, methylcellulose crotonate, and stearyloxypoly(ethyleneoxy) acrylate (containing 1 to about 40 moles of ethylene oxide). Mixtures of these materials may be used as well.

The protective colloid may be sourced from a reactive surfactant. Reactive surfactants may include nonylphenoxy poly(ethyleneoxy) acrylate (containing from about 1 to 40 moles of ethylene oxide), nonylphenoxy poly(ethyleneoxy) methacrylate (containing from 1 to about 40 moles of ethylene oxide), nonylphenoxy poly(ethyleneoxy) crotonate (containing from about 1 to about 40 moles of ethylene oxide), bis-nonylphenoxy poly(ethyleneoxy) fumerate (containing from about 1 to about 40 moles of ethylene oxide), phenoxypoly(ethyleneoxy) acrylate (containing from about 1 to about 40 moles of ethylene oxide), perfluoroheptoxypoly (propyloxy) acrylate, perfluoroheptoxypoly (propyloxy) methacrylate, sorbitol acrylate, sorbitol methacrylate, and allyl methoxy triethylene glycol ether.

Preferred protective colloid or reactive surfactants which may be used in the polymeric dispersants of the invention therefore may include polymers from stearyl acrylate, stearyl methacrylate, lauryl acrylate, lauryl methacrylate, nonylphenol acrylate, nonylphenol methacrylate, nonylphenoxy poly(ethyleneoxy)ₙ methacrylate, wherein n is from 1 to about 40, including all values and increments therein, nonylphenoxy poly(ethyleneoxy)ₙ acrylate, wherein n is from 1 to about 40, including all values and increments therein, methoxypoly(ethyleneoxy)ₙ methacrylate, wherein n is from about 1 to about 40, including all increments and values therein, methoxypoly(ethyleneoxy)ₙ acrylate, wherein n is from about 1 to about 40, including all values and increments therein, stearyloxypoly(ethyleneoxy)ₙ methacrylate, wherein n may be from about 1 to about 20, stearyloxypoly(ethyleneoxy)ₙ acrylate, wherein n may be from about 1 to about 20, including all increments and values therein, perfluoro or highly fluorinated C₁-C₁₈ alkyl methacrylate, perfluoro or highly fluorinated C₁-C₁₈ alkyl acrylate (such as trihydroperfluoro undecyl methacrylate and trihydroperfluoro undecyl acrylate), poly(propylene glycol) methyl ether methacrylate, poly(propylene glycol) methyl ether acrylate, poly(propylene glycol) 4-nonylphenol ether methacrylate, poly(propylene glycol) 4-nonylphenol ether acrylate, methacryloxy-trimethylsiloxy-terminated polyethylene oxide, and acryloxytrimethylsiloxy-terminated polyethylene oxide.

The protective colloid or reactive surfactant itself may have a molecular weight preferably ranging from about 200 to 2,000, including all values and increments therein. The colloid or reactive surfactant segment also includes a moiety which enables it to attach to the backbone hydrophilic segment of the polymer.

As noted above, the dispersant may also include a hydrophobic backbone segment. The hydrophobic component of the dispersant may therefore include at least one electron rich functional group. Such functional group may include a polymer or copolymer containing electron rich functional groups, such as aromatic groups, including but not limited to alkyl aromatic groups and substituted aromatic groups. The functional group may include nonylphenyl, mono-, di-, and tri-styrene phenyl, polydimethylsiloxy, stearyl, and fluoronated hydrocarbon containing groups. Examples of such monomers may include, but are not limited to polymerizable monofunctional vinyl monomers from Toagosei Co. of Tokyo, Japan under the trade name ARONIX M-117, mono-methacryloxypropyl terminated polydimethylsiloxane from Gelest, Inc. of Morrisville, Pa. under the tradename MCR-M11, and polydimethylsiloxane co-polypropylene glycol methacrylate, and polydimethylsiloxane co-polypropylene glycol methacrylate. Non-siloxyl hydrophobic monomers may be derived from long chain aliphatic groups, long chain alcohols, and alkyl aryl alcohols, such as strearyl or lauryl acrylate or methacrylate or nonyl phenol acrylate or methacrylate.

The hydrophobic and protective colloid groups may also include poly(alkylene glycol) 2,4,6,-tris-(1-phenylethyl) phenyl ether methacrylate and its di and mono derivatives wherein the alkylene group may contain from 3 to 10 carbon atoms. A commercially available monomer for the hydrophobic and protective colloid groups may include poly(ethylene glycol) 2,4,6-tris-(1-phenylethyl) phenyl ether methacrylate available from Rhodia, USA of Cranbury, N.J. under the tradename SIPOMER/SEM 25. Other preferred hydrophobic groups include polydimethylsiloxane methacrylate from Gelest, Inc., polypropylene glycol nonylphenylether acrylate from Toagosei Co. under the trade name ARONIX M-117 and polydi-methylsiloxane-co-polypropylene glycol methacrylate. The hydrophobic monomer may have a molecular weight of from about 200 to about 5,000, including all values and increments therein.

The molar ratio of the hydrophilic group to the hydrophobic groups and protective colloid groups may range from about 13:2:2 to about 5:10:1.

The wax dispersants herein may be initially represented by the following formula:

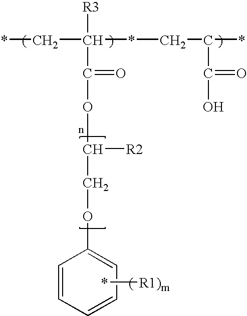

wherein n is an integer from 0 to 20, m is an integer from 1 to 3 and each R1 is independently selected from C₁-C₉ alkyl, or aryl-C₁-C₉ alkyl, provided that at least one of said R1 is aryl-C₁-C₉ alkyl and each R2 and R3 is independently selected from H and —CH₃. In the foregoing formula, the acrylic acid moiety may be polymerized to provide the backbone of the wax dispersant. The pendant chains of the polymer may include at least one hydrophobic segment and at least one protective colloid or reactive surfactant segment as described above. It should be appreciated however, that the alkyl group of the methacrylate ester may be replaced with other functional groups such as (ethylene glycol) 2,4,6-tris-(1-phenylethyl)phenyl.

The dispersant may also be represented by the following formula:

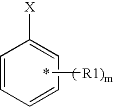

wherein m is an integer from 1 to 3, X is a polymerizable group, preferably connected to the aromatic group by —O—, —N—, or —S—, and each R1 may be independently selected from C₁-C₉ alkyl, or aryl-C₁-C₉ alkyl, provided that at least one of said R1 is aryl-C₁-C₉ alkyl. The polymeric tail may include the formula:

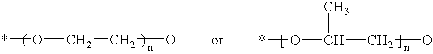

wherein n is from 0 to 30. The polymeric tail may be attached to an alkylacrylo-functional group that may provide a polymerizable backbone for the dispersant. For example, the R1 may be a styrene functionality, X may be ethylene glycol, and the length of the repeating unit may be from 0 to 30.

As noted above, the wax dispersant may also include a hydrophobic segment that may comprise a polymer or copolymer containing electron rich functional groups. Accordingly, the dispersant may be comprised of a plurality of methacrylate derivative monomers, including a substituted methacrylate ester monomer wherein an alkoxyl group on the methacrylate ester may be replaced with a siloxyl substituent, which may be represented by the following formula:

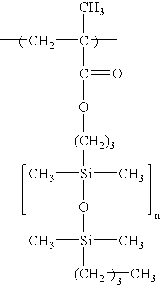

wherein n ranges from 1 to 20.

As therefore should be clear from the above, the wax dispersant herein may include random repeat units derived from a hydrophilic segment such as:

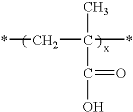

wherein x ranges from about 4 to about 20, including all increments and values therein and a segment such as:

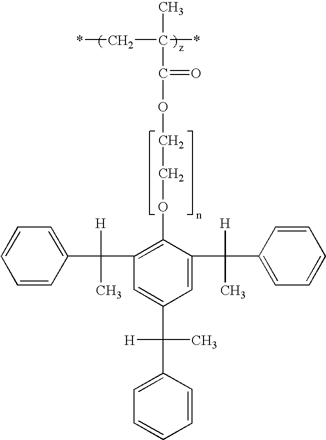

wherein z ranges from about 1 to about 5 including all increments and values therein and n ranges from about 1 to about 30, including all values and increments therein; and a segment such as:

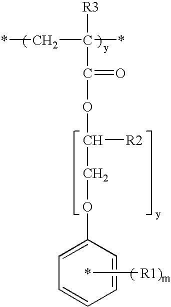

wherein y is an integer from about 1 to about 10, including all increments and values therein, n is an integer from about 1 to about 20 including all increments and values therein, m is an integer from about 1 to about 3 including all increments and values therein and each R1 may be independently selected from C₁-C₉-alkyl, or aryl-C₁-C₉-alkyl, provided that at least one of said R1 is aryl-C₁-C₉-alkyl, and each R2 and R3 may be independently selected from H and —CH₃.

The polymeric wax dispersant may be formed from corresponding monomers via free radial polymerization and may use initiators and chain transfer agents to control the polymer molecular weight and terminate the reaction. Exemplary free radical initiators may include the azo-type and peroxide-type initiators such as dimethyl 2,2′-azobisisobutyrate (V-601) from Waco Chemical & Supply Co. and 2,2′-azobisisobutyrylnitrile (AIBN) available from E.I. DuPont of Wilmington, Del. under the trade name VAZO 64. Exemplary chain transfer agents may include C₁-C₂₀ alkylthiol groups, such as n-C₁₂ thiol. In addition, the chain transfer agents may include phenylalkyl mercaptans or 3-mercapto-1,2 propanediol.

Once the wax dispersion has been formed the polymer latex may be prepared in the presence of the dispersion. Examples of such preparation are provided in Table 1 below. The latex may be a resin material composed from one or more compounds including monomers and chain transfer agents. The monomers and chain transfer agents may include relatively long chain hydrocarbons containing functional groups, aromatic hydrocarbons, ester moieties containing relatively long chain alkyls or carboxylic acid compounds. As understood herein long chain hydrocarbons may include C₅-C₂₅ alkyls, including all ranges and increments therein. Exemplary compounds may include styrene, butyl acrylate, methacrylic acid, lauryl methacrylate, 2-hydroxyethylmethacrylate, 1-dodecanthiol and combinations thereof.

The latex synthesis in the wax dispersion may be carried out using a surfactant. The surfactant may include an alkylene glycol ether, such as those available from Kao Specialties of Highpoint, N.C., under the tradename Akypo RLM 100. The surfactant may be present between about 0-5% concentration, including all values and increments therein, such as about 1.5%.

The latex compounds, the wax dispersion, and the surfactant may be added to de-ionized water to form a monomer mixture. The mixture may be formed under an inert atmosphere, such as a nitrogen atmosphere, at a temperature in the range of 65 to 85° C., including all values and increments therein, such as 76° C. The monomer mixture may be mixed for approximately 5 to 60 minutes, including all values and increments therein, such as 15 minutes.

A polymerization initiator, such as ammonium persulfate, may be added to at least a portion of the monomer mixture, such as in the range of about 1% to 100% by volume of the monomer mixture including all values and increments therein, and mixed for approximately 5 to 60 minutes including all values and increments therein, such as 20 minutes. Then any remaining monomer mixture may be added over a period of time in the range of 10 minutes to 24 hours, including all values and increments therein, such as in the range of about 3.5 to 4.5 hours. Once substantially all of the monomer mixture has been added to the initiator, the mixture may be combined for a time in the range of 10 minutes to 24 hours, including all values and increments therein, such as 7 hours. The temperature of the mixture may be maintained at or about 65 to 85° C., including all values and increments therein, such as 67 to 78° C. The latex may then be recovered and removed from the mixture by filtration or another similar process.

The resulting latex may therefore include wax in the range of about 1 to 25% by weight, including all values and increments therein, such as 4% to 10%, etc. Where the latex includes an ester moiety containing a relatively long chain alkyl, the ester moiety containing the relatively long chain alkyl may be present between 0.1 to 10% by weight of the latex, including all values and increments therein. However, as alluded to above, the polymer latex may also be one that does not make use of relatively long chain acrylic esters.

Table 2 provides characterization data for the exemplary polymer latexes formed in the presence of the wax dispersion. The polymer formed in the latex may be one that includes an onset glass transition temperature Tg of greater than about 40° C. In addition the onset glass transition temperature may be less than about 65° C. For example, the glass transition temperature may fall within the range of 45 to 55° C., including all values and increments therein. The number average molecular weight (Mn) of the polymer formed in the latex may be greater than about 6,500. In addition, the Mn may be less than about 10,000. For example, the Mn may be in the range of about 7000 to 8000, including all values and increments therein. The weight average molecular weight (Mw) of the polymer formed in the latex may be greater than about 20,000. The Mw may also have any value or range less than 60,000. For example, the Mw may be in the range of 25,000 to about 40,000 including all values and increments therein. The polydispersity (PD) of the polymer formed in the latex may be greater than about 3.00. In addition, the PD may be less than about 5.75. For example, the PD may be in the range of about 3.5 to about 5.5, including all values and increments therein.

The particle size diameter (PSD) of the particles formed upon heating of the polymer latex formed in the wax dispersion may be in the range of about greater than 339 nm volume average and 314 nm number average. In addition, the particle size diameter may be less than 1,000 nm volume average and 1,000 nm number average. Accordingly, the particle size diameter volume average may be in the range of 700 to 900 nm and the particle size diameter number average may be in the range of 450 to 900 nm, including all values and increments therein.

With respect to Table 2, it can be observed that a decrease in Tg is observed for those polymers produced in the presence of the wax dispersion, which may be attributed to a plasticizing effect of the wax on the polymer backbone. In addition, polymers produced in the presence of the wax dispersion indicated a lowering of the number average molecular weight. However, the relative size of the latex droplets in the presence of the wax dispersion (Latex 1, Latex 2, Latex 3) may be observed to be higher than the size of the latex droplets not prepared in the presence of a wax dispersion (Comparative Latex 1). This may be due to a swelling of the wax droplet upon introduction of monomer and the ensuing polymerization, which may then provide for relatively more wax on the surface of the polymer, rather than encapsulated within the polymer matrix.

The polymer latex formed in the presence of the wax dispersion may then be utilized to form toner particles. See Table 3. In addition, an organic solvent may optionally be utilized, e.g., an organic alcohol such as isopropanol. Furthermore, one may also incorporate a second polymer latex that does not include an ester moiety that contains a relatively long chain alkyl, such as lauryl methacrylate.

The resultant fused toner particles may have wax present between approximately 1 to 20% by weight of the toner, including all values and increments therein, such as about 2 to 9% by weight wax in the toner. In addition, the resultant fused toner particles may have a particle size diameter (by volume) in the range of 0.1 to 25 μm, including all values and increments therein, such as 9.9 μm, 8.8 μm, 6.7 μm, etc.

The circularity of the fused particles may be in the range of 0.80 to 0.98 including all values and increments therein. See Table 4. Circularity may be measured using a flow particle image analyzer (available from Malvern under the product number FPIA-2100). The circularity of a particle may be understood as a ratio of the circumference of a circle having the same projected area as the particle to the circumference of the projected area of the particle. The more spherical the particle, the closer the circularity is to 1.

The resultant toner particles may also have a fusing onset temperature in the range of 100° C. to 160° C., including all values and increments therein, such as 120° C., 130° C. or 140° C. The fusing onset temperature may be understood as the temperature in which the toner particles begin to soften and adhere to the media. The fusing temperature window may be in the range of 0° C., (i.e., there is no window,) to about 60° C., including all values and increments therein, such as 20° C., 35° C. or 50° C. The fusing temperature may be measured on various basis weight paper, such as 16 gram/m² paper or 32 gram/m² paper. To measure the fusing temperature, the paper may be passed, for example, through a fuser apparatus. The apparatus may include a pair of contacting rolls including aluminum cores coated with a thick layer of silicone rubber, the silicone rubber being coated with a thin film of a fluoropolymer. The rolls may be compressed together via a spring load imparting a relatively thick nip between the rolls. Each roll may include a heat lamp. However, it should be appreciated that other methods and apparatus may be utilized to measure the onset fuse temperature and fuse temperature window.

### EXAMPLES

The examples provided herein are for illustration purposes only and are not meant to limit the scope of this specification and the claimed subject matter appended hereto.

### Example 1

Various latex formulations as described in Table 1 were prepared as follows.

TABLE 1

| | Com- | | Com- | | Latex 1 | | Latex 2 | | | |
|---|---|---|---|---|---|---|---|---|---|---|
| Latex | parative | | parative | | [5% X- | | [3.8% | | Latex 3 | |
| Component | Latex 1 | | Latex 2 | | 1197] | | PW500] | | [4% WE6] | |
| Styrene | 514.6 | g | 257.3 | g | 257.3 | g | 257.3 | g | 257.3 | g |
| Butyl | 75.6 | g | 53.3 | g | 37.8 | g | 37.8 | g | 37.8 | g |
| Acrylate | | | | | | | | | | |
| Methacrylic | 4.90 | g | 2.75 | g | 2.50 | g | 2.60 | g | 2.75 | g |
| acid | | | | | | | | | | |
| 2- | 3.00 | g | 1.50 | g | 1.70 | g | 1.60 | g | 1.50 | g |
| Hydroxy- | | | | | | | | | | |
| ethyl | | | | | | | | | | |
| methacrylate | | | | | | | | | | |
| Lauryl | 31.50 | g | 0 | g | 15.75 | g | 15.75 | g | 15.75 | g |
| methacrylate | | | | | | | | | | |
| 1- | 10.80 | g | 5.4 | g | 5.4 | g | 5.4 | g | 5.4 | g |
| Dodecane- | | | | | | | | | | |
| thiol | | | | | | | | | | |
| Ammonium | 4.00 | g | 2.10 | g | 2.00 | g | 2.00 | g | 2.10 | g |
| persulfate | | | | | | | | | | |
| De-ionized | 1000 | g | 310 | g | 255 | g | 300 | g | 310 | g |
| water | | | | | | | | | | |
| Akypo RLM | 10.2 | g | 4.90 | g | 4.72 | g | 4.50 | g | 4.90 | g |
| 100 | | | | | | | | | | |
| Wax | 0 | g | 0 | g | 195 | g | 150 | g | 130 | g |
| Dispersion | | | | | | | | | | |

| | | | | | |
|---|---|---|---|---|---|
| Yield | 93% | 96% | 94% | 95% | 94% |

It should be noted that the above Polymeric alkylene glycol ether, Akypo RLM-100 available from Kao Specialties and de-ionized water were added to a 1 L reactor flask and stirred with a mechanical stirrer under a nitrogen atmosphere. The solution was then heated and stirred at 76° C. All monomers and chain transfer agents were thoroughly mixed. About 1% by weight of the monomer mixture was transferred to the reactor and stirred at 76° C. for about 15 minutes. Reference to “5% X-1197” is reference to polyethylene based wax and the concentration of wax in the latex/dispersion mixture is 5.0% by weight. Similarly, reference to 3.8% PW500 is reference to a polyethylene type wax at a concentration in the latex/dispersion mixture of 3.8% by weight. Reference to 4% WE6 is reference to an ester type wax present in the latex/dispersion mixture at 4% by weight.

Ammonium persulfate was then dissolved in 40 g of de-ionized water and added over 20 minutes. The reaction mixture was stirred for 20 minutes at 75° C. The remaining monomer mixture was added over a 3.5 to 4.5 hour period. Following the completion of monomer addition, the reaction mixture was stirred for 7 hours at 76° C. and then cooled. The latex solution was then filtered.

The latex composites were then characterized with respect to particle size distribution, molecular weight and onset glass transition temperature. The results of the analysis are reported below in Table 2.

TABLE 2

| | | | Tg (° C.) |
|---|---|---|---|
| | PSD (Vol/Number) | | Onset 1^{st} |
| Latex | nm | Mn/Mw/PD | Scan |
| Comparative | 339 nm/314 nm | 9.8K/56.9K/5.76 | 62 |
| Latex 1 | | | |
| Latex 1 | 844 nm/829 nm | 7.1K/31.9K/4.44 | 50 |
| Latex 2 | 889 nm/667 nm | 7.2K/36.4K/5.00 | 47 |
| Latex 3 | 742 nm/493 nm | 7.8K/27.9K/3.58 | 49 |

As can be seen from the above, the particle size increased for the latexes particles including the wax. In addition, the molecular weight number and weight averages decreased in the wax containing latexes. Furthermore, the onset glass transition temperature was decreased for the wax containing latexes.

### Example 2

A number of chemically processed toner compositions were prepared utilizing latex compositions with and without wax. The toner compositions are described below in Table 3.

TABLE 3

| | | | | | | | Coalescence | |
|---|---|---|---|---|---|---|---|---|
| | | | | | | | Temp | Wax In |
| | | Latex | Comp. | | | 1% | and | Final |
| | | Amt | Latex 2 | Pigment | Added | HNO₃ | time | Toner |
| Toner | Latex | (g) | (g) | (g) | Wax (g) | (g) | (° C./hr) | (%) |
| Comp. | Comp. | 300 | 0 | 112 (PB | 65 (X- | 212 | 78/2 | 4.7 |
| Toner 1 | Latex 1 | | | 15:3) | 1197) | | | |
| Toner 1 | Latex 1 | 300 | 0 | 114 (PB | 0 | 229 | 78/2 | 4.9 |
| | (5% X- | | | 15:3) | | | | |
| | 1197) | | | | | | | |
| Comp. | — | 0 | 300 | 126 | 49 (X- | 250 | 72/0.5 | 2.8 |
| Toner 2 | | | | (Regal | 1197) | | | |
| | | | | 330) | | | | |
| Toner 2 | Latex 2 | 100 | 200 | 114 (PB | 90 | 273 | 78/1.5 | 8.4 |
| | (3.8% | | | 15:3) | (PW500) | | | |
| | PW500) | | | | | | | |
| Toner | Latex 2 | 100 | 200 | 114 (PB | 0 | 273 | 78/3 | 3.3 |
| 2a | (3.8% | | | 15:3) | | | | |
| | PW500) | | | | | | | |
| Toner 3 | Latex 1 | 100 | 200 | 200 | 0 | 173 | 78/2 | 8.6 |
| | (5% X- | | | (PY180/ | | | | |
| | 1197) | | | WE6) | | | | |
| Toner 4 | Latex 1 | 100 | 200 | 114 (PB | 105 (X- | 241 | 78/2 | 11 |
| | (5% X- | | | 15:3) | 1197) | | | |
| | 1197) | | | | | | | |
| Toner 5 | Latex 3 | 100 | 200 | 114 (PB | 225 | 241 | 78/2 | 11 |
| | (4% | | | 15:3) | (PW500) | | | |
| | WE6) | | | | | | | |

Note that in the above table PB 15:3 is Pigment Blue, available from Clariant, PY180 is Pigment Yellow, also available from Clariant and Regal 330 is Black Pigment.

In general, the toner compositions were prepared as follows. About 300 grams of latex and de-ionized water (about 300 g) were placed in a 2 L reactor. The pH of the latex was modified to about 7.5 by the addition of 10% sodium hydroxide solution. To the latex was then added a pigment dispersion and any additional wax dispersions, followed by isopropanol. About 200 g of de-ionized water was used in rinsing the pigment dispersion and/or wax dispersion containers. The mixture was then heated to about 35° C.

A 1% nitric acid solution was then added dropwise, until the particle size of the flocculate was about 4 to 5 μm in size. The solution was then slowly heated to about 68° C. to 78° C. and the coalescence of the aggregates was monitored. On achieving optimum coalescence, heating was discontinued. The solution was then allowed to cool. The solution was then filtered through a coarse screen cloth to remove any chunky solids, followed by filtration. The residue was washed at least 5 times with about 500 mL of de-ionized water, followed by filtration. The resulting toner particles were dried at 38° C. for approximately 48 hours.

The resulting toner particles were characterized in terms of the particle size distribution, circularity and fuse onset temperatures and fuse temperature windows for various paper weights. The results of the testing is summarized in Table 4 below.

TABLE 4

| | | | Fuse Temp | Fuse Temp |
|---|---|---|---|---|
| | | | (16 g/m²) | (32 g/m²) |
| Toner | PSD (Vol) | | Onset (° C.)/ | Onset (° C.)/ |
| Composition | (μm) | Circularity | Window (° C.) | Window (° C.) |
| Comp. Toner 2 | 6.9 | 0.939 | 120/0 | 130/20 |
| Toner 2 | 6.7 | 0.952 | 120/55 | 135/40 |
| Toner 2a | 8.8 | 0.933 | 120/45 | 130/45 |
| Toner 3 | 9.3 | 0.943 | 120/50 | 130/45 |
| Toner 4 | 9.9 | 0.937 | 125/20 | 140/35 |
| Toner 5 | 11.2 | 0.868 | 120/30 | 135/40 |

As can be seen from the above, Toner 2, which utilized Latex 2 in combination with Comparative Latex 2, along with added wax ultimately had about 8.4% (wt.) wax. Toner 2a, which utilized Latex 2 with Comparative Latex 2, had no added wax. However, Toner 2a, which had a wax concentration of about 3.3% (wt) had a fuse release window that was similar to Toner 2. As the fuse release window is dependent upon the amount of wax present on the surface, as opposed to that present in the bulk, it appears that more wax may be present on the surface in Toner 2a than in Toner 2. Accordingly, latex preparation in the presence of the wax dispersion may allow for use of relatively low levels of fuser release agent (wax) with adequate fuse release windows as well as the ability to provide good print quality with reduced filming of the developer roller and/or doctor blade.

The effects of heating on particle size in a latex without wax (Comparative Toner 1) and a latex prepared in the presence of a wax dispersion followed by an aggregation process (Toner 1) was evaluated by measuring the particle size of the latex aggregates at various temperatures. The results are illustrated below in Table 5.

TABLE 5

| Toner | | | | | 58° C. | | | 78° C. |
|---|---|---|---|---|---|---|---|---|
| Composistion | 23° C. | 34° C. | 43° C. | 58° C. | (45 min.) | 65° C. | 78° C. | (2 hours) |
| Toner 1 (5% X- | 0.719 μm | 6.35 μm | 6.95 μm | 8.67 μm | 9.3 μm | 11.12 μm | 10.65 μm | 10.55 μm |
| 1197) | | | | | | | | |
| Comp. Toner 1 | 0.719 μm | 5.3 μm | 5.33 μm | 5.07 μm | | 4.92 μm | 4.53 μm | 4.85 μm |
| (0% wax in latex) | | | | | | | | |

As can be seen from the above, the particles incorporating lauryl methacrylate including a wax composition (Toner 1) grew with the addition of heat. The particles incorporating lauryl methacrylate without wax in the latex (Comparative Toner 1) remained at substantially the same size upon the addition of heat.

The foregoing description of several methods and an embodiment of the invention has been presented for purposes of illustration. It is not intended to be exhaustive or to limit the invention to the precise steps and/or forms disclosed, and obviously many modifications and variations are possible in light of the above teaching. It is intended that the scope of the invention be defined by the claims appended hereto.

What is claimed is:

1. A method of forming a chemically processed toner comprising:
forming a wax dispersion comprising wax particles dispersed in a fluid containing a dispersant;
introducing to said wax dispersion polymerizable monomer and polymerizing said monomer and forming a latex of polymer particles in said wax dispersion;
introducing a dispersion containing pigment particles;
forming clusters by inducing the wax, polymer and pigment particles to associate including growth of the clusters to form a plurality of clusters; and
heating at a temperature to coalesce together the clustered particles to form coalesced particles of toner.

2. The method of claim 1 wherein said polymerizable monomer includes an acrylic ester having the following formula: 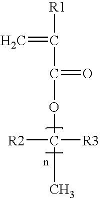
wherein R1, R2 and R3 may be a hydrogen, an alkyl group, a substituted alkyl group, an aryl group or a substituted aryl group and wherein n is an integer have a value of greater than 5.

3. The method of claim 2 wherein said acrylic ester is present at a level of 5.0% by weight or greater.

4. The method of claim 1 wherein said wax dispersant comprises a copolymer including a hydrophilic component and a protective colloid component.

5. The method of claim 2 wherein said dispersant has a weight average molecular weight (Mw) of about 5,000-30,000.

6. The method of claim 1 wherein said wax dispersant comprises a terpolymer including a hydrophilic component, a protective colloid component, and a hydrophobic component.

7. The chemically prepared toner of claim 6, wherein the polymeric dispersant is derived from a free radical polymerization reaction of a reaction mixture including a hydrophilic component selected from the group consisting of acrylic acid monomer and alkylacrylic acid monomer, a hydrophobic component selected from the group consisting of an alkylarylpoly(C₃-C₁₀-alkylene)glycol alkylacrylate, a polydimethylsiloxane methacrylate, and a polydimethylsiloxane-co-poly(C₃-C₁₀-alkylene)glycol methacrylate, and a protective colloid component selected from the group consisting of a tri-alkylarylpolyethyleneglycol alkylacrylate, and a polydimethylsiloxane-co-polyethylene glycol methacrylate.

8. The method of claim 1 wherein said wax is selected from the group consisting of polyolefin wax, ester wax, polyester wax, metal salts of fatty acids, fatty acid esters, partially saponified fatty acid esters, higher fatty acid esters, higher alcohols, paraffin wax, amide waxes and polyhydric alcohol esters.

9. The method of claim 1 wherein said wax is present in said toner at a level of about 1-20% by weight.

10. The method of claim 1 wherein said formation of cluster is promoted by heating.

11. The method of claim 1 wherein said fluid comprises an aqueous medium including an organic alcohol.

12. The method of claim 1 wherein said aggregates have a diameter of approximately 0.1 to 25 μm.

13. The method of claim 1 wherein said heating to fuse the clustered particle comprises heating at a temperature above the glass transition temperature (Tg) of the polymerized monomer.

14. A method of forming a chemically processed toner comprising:
forming a wax dispersion comprising wax particles dispersed in a fluid containing a dispersant, said dispersant comprising a copolymer containing a hydrophilic component and a protective colloid component having a weight average molecular weight of about 5,000-30,000, wherein said wax is present in said dispersion at about 1-25% by weight;
introducing to said wax dispersion polymerizable monomers wherein one of said monomers comprises an acrylic ester having the following structure: 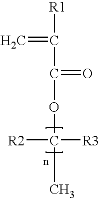
wherein R1, R2 and R3 may be a hydrogen, an alkyl group, a substituted alkyl group, an aryl group or a substituted aryl group and wherein n is an integer have a value of greater than 5;
polymerizing said monomers and forming a latex of polymer particles in said wax dispersion;
introducing a dispersion containing pigment particles;
forming clusters by inducing the wax, polymer and pigment particles to associate including growth of the clusters to form a plurality of clusters; and
heating at a temperature to fuse together the clustered particles to form coalesced particles of toner.

15. The method of claim 14 wherein said wax in said toner is present at a level of about 1-20% by weight and said acrylic ester is present at a level of between 0.1-10% by weight.

16. The method of claim 14 wherein fluid comprises an aqueous medium including an organic alcohol.

17. The method of claim 14 wherein said toner particles have a fusing onset temperature of about 100 to about 160° C.
